(19) United States
(12) Patent Application Publication
(10) Pub. No.: US 2005/0125433 A1
(43) Pub. Date: Jun. 9, 2005

(54) Data summation system and method based on classification definition covering plural records

(75) Inventor: Naoki Akaboshi, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/037,036

(22) Filed: Jan. 19, 2005

Related U.S. Application Data
(63) Continuation of application No. PCT/JP02/12789, filed on Dec. 5, 2002.

(51) Int. Cl. G06F 17/00

(52) U.S. Cl. 707/101

(57) ABSTRACT

The invention provides a data summation system which obtains a summation of a plurality of records, which are composed of a plurality of data items and stored in a table form, based on a predetermined rule. The data summation system comprises a definition unit receiving a definition which specifies records of relevant classification covering two or more records stored in the table form, a specifying unit specifying the records of the relevant classification covering the two or more records, and a classification summation unit obtaining a summation of the plurality of records composed of the plurality of data items and stored in the table form, according to the definition received by the definition unit, with reference to a classification result provided by the specifying unit.

### CROSS-REFERENCE TO RELATED APPLICATIONS

This application is a U.S. continuation application which is filed under 35 USC 111(a) and claims the benefit under 35 USC 120 and 365(c) of International Application No. PCT/JP2002/012789, filed on Dec. 5, 2002, the entire contents of which are hereby incorporated by reference.

### BACKGROUND OF THE INVENTION

1. Field of The Invention

The present invention generally relates to an information processing system, and more particularly to a data summation system and a data summation method for utilizing the stored information.

2. Description of The Related Art

In many cases, the information which is intended for putting it in practical use with the computer is accumulated as a table-form data (table data) like the transaction information to record daily dealings, and this table-form data contains a number of records each having a fixed data structure and retaining information of one of the corresponding number of events. In each of the records, the information representing the event is divided into information items, and they are arranged and stored in the storage areas (fields).

FIG. 1 shows an example of such table-form data. In the example of FIG. 1, the receipt number of reference numeral 101, the date of sales of reference numeral 102, the customer number of reference numeral 103, the goods of reference numeral 104, and the amount of sales of reference numeral 105, which are arrayed in columns of the table, constitute the respective fields.

And, for example, the record 106 at the first line of the table of FIG. 1 comprises data items of the respective fields: the receipt number 00001, the date of sales Jun. 30, 2002, the customer number 10001, the goods A, and the amount of sales 3000.

In utilizing the information accumulated as table data, the records are classified according to the rules based on the values stored in the specific field in the respective records. And summation is carried out for every set of the classified records (categories), so that the difference and tendency between the categories are analyzed.

FIG. 2 shows a result of data summation of the records in the table-form data shown in FIG. 1. The records are classified into two categories depending on whether the date-of-sales field 102 of each record of the table-form data of FIG. 1 is in June or in July. Specifically, the result of the data summation is the result of totaling the amount-of-sales fields of the records corresponding to one of the two categories on a month basis. The result of the data summation is composed of the two columns of the monthly classification 201 and the total amount 202.

Specification of the classification rules is possible by the conventional method. Each classification based on these classification rules is characterized in that the classification can easily be performed by applying the rule to each single record.

The first example of the classification rules is of category type, and this is the classification rule which is intended to perform the classification based on the items of daily necessaries, fresh foodstuffs, etc.

The second example of the classification rules is of time type, and this is the classification rule in which the classification is performed depending on whether the time field of a certain record meets the predetermined conditions, for example. There are monthly classifications, such as January or February, weekly classifications, daily classifications, etc.

The third example of the classification rules is of range type. For example, the classification is performed depending on whether the amount of sales of a certain record belongs to the range of 1 million yen or less or the range of 1 million yen to 10 million yen.

The fourth example of the classification rules is of whole value type. For example, the classification is performed based on the value of the record. For example, in the case of a large-sized store with the register number of 1 to 10, the classification is performed by making use of all the values of the recorded one of the register numbers 1 to 10.

FIG. 3 shows the composition of a conventional information processing system for utilizing the information which is stored therein.

The conventional system of FIG. 3 generally comprises an information-processing device 301, an input device 302, a display device 303, a database 304, and a classification definition accumulation unit 305.

The information-processing device 301 has several units to perform various kinds of processings, and generally comprises a data registration unit 311, a classification definition unit 312, a classification instructions unit 313, and a classification summation unit 314.

The display device 303 displays a data screen etc. The input device 304 performs various inputs and it may be a mouse, a keyboard, etc. The data registration unit 311 creates records from the data inputted from the input device 302, and registers them into the database 304 (accumulation).

The classification definition unit 312 accumulates the classification definition inputted from the input device 302 into the classification definition accumulation unit 305.

The classification instructions unit 313 specifies the classification definition accumulated in the classification definition accumulation unit 305 according to the instructions inputted from the input device 302, and sends it to the classification summation unit 314.

The classification summation unit 314 classifies the records accumulated in the database 304, and performs the data summation processing. The database 304 is provided to accumulate the data therein as the records. A classification definition means a definition of a classification registered in the classification definition accumulation unit 305.

The classification summation unit 314 takes out the record currently recorded from the sales database one by one, and performs data summation processing for every corresponding classification according to the field of each record, with reference to the classification definition. And the result of the classification and data summation by the classification summation unit 314 is displayed on the display device 303.

Conventionally, the rule which can be defined as a classification definition only applied the rule about one record, and is limited to the classification rule that can be classified immediately. However, there is a case in which it is desired to use the analysis result by various analysis tools called business intelligence as a classification definition which classifies a record.

Since it is necessary to carry out the classification definition which went over two or more records when classifying a record based on such an analysis result, it cannot total under the conventional simple classification rule.

Data mining occurs as a representative of the concrete thing of the analysis tool called such business intelligence. Data mining is the tools of analysis of discovering a certain regularity and law nature out of abundant data. Data mining means the work which analyzes a vast quantity of data, converts it into valuable information, and links the valuable information to the business action. Generally as the techniques of data mining used, there are correlation analysis and clustering.

The correlation analysis is one of the analysis tools of data mining, and this is the technique of discovering the combination pattern of the purchased goods, for example.

In the analysis, the contents of the receipts when the customer purchased something are accumulated in the POS (point-of-sales) system. In this case, one receipt is called the transaction. Suppose that 20 customers, among the customers of the 100 receipts collected, purchased the goods A, and 12 customers purchased both the goods A and the goods B. In this case, one goods is called the item. Moreover, usually, two or more items are contained in one transaction.

At this time, based on the following definition formula (1): “support of item” is represented by the ratio of the number of the transactions containing that item to the total number of the transactions, it is determined that the “support of the goods A” is 20% and the “support of the goods A and B” is 12%. Accordingly, by using the simple probability calculation, it is determined that “60% of the customers (=12%/20%) who purchase the goods A also purchase the goods B”.

This is expressed as “A->B; confidence 60%; support 12%”, and it is called a correlation rule. Namely, the correlation rule “A->B” has the confidence which is represented by the following formula:

Confidence of “A->B”=the ratio of support of AΛB (both A and B are purchased) to support of A where the sign “A” indicates the purchase of both A and B. For example, the correlation rule “bread ->butter; confidence 70%” means that “70% of the customers who purchase bread also purchase butter”.

In this manner, the rule, such as “the customer who purchases the goods A also purchases the goods B”, can be obtained as a result of the correlation analysis.

For example, the two concrete rules “the customer who purchased the goods A and the goods B together” and “the customer who purchased the goods A and the goods D together” are extracted from the result which is obtained by performing the correlation analysis for the data as shown in FIG. 1, and it is not possible for the conventional analysis tool to perform data summation according to the classification based on these rules.

This is because classification is impossible by viewing one record and applying a simple rule about whether a certain record meets these rules. In this manner, the correlation analysis is extracting the relation covering two or more records instead of the result obtained from the records of simple substance.

On the other hand, clustering is one of the other analysis tools of data mining, and this clustering is the technique of gathering similar data in the same group. For example, sales data can be classified with the application of the clustering technique, and two classifications called a young-man-oriented customer layer and a family-oriented customer layer can be discovered.

FIG. 4 shows an example of data mining by clustering. In this example of the clustering, the grouping of the records stored in the table-form data 401 into the two classifications 402 (classification 1) and 403 (classification 2) which are similar to each other with respect to the four attributes of the annual income, the gender, the age and the goods.

When it is desired to carry out classification and data summation processing by using the result of such clustering, it cannot be determined which classification a certain record belongs to only by referring to individual single records. This is because the clustering is provided to create the classification by taking into consideration only the individual single records but also the similarity to other records.

Therefore, it is impossible for the conventional system to use, as a new classification definition, totally or partially the result acquired with the application of data mining for the table-form data (table data) accumulated in the database, and to obtain a summation of the records of the original table-form data. For this reason, there is the demand for a new mechanism for classifying records according to the classification rules which cover plural records and performing data summation processing of such classified records.

### SUMMARY OF THE INVENTION

An object of the present invention is to provide an improved data summation system and method in which the above-described problems are eliminated.

Another object of the present invention is to provide a data summation system and method which is capable of classifying records according to classification rules covering plural records, and performing data summation processing of the records.

In order to achieve the above-mentioned objects, the present invention provides a data summation system which obtains a summation of a plurality of records, which are composed of a plurality of data items and stored in a table form, based on a predetermined rule, the data summation system comprising: a definition unit receiving a definition which specifies records of relevant classification covering two or more records stored in the table form; a specifying unit specifying the records of the relevant classification covering the two or more records; and a classification summation unit obtaining a summation of the plurality of records composed of the plurality of data items and stored in the table form, according to the definition received by the definition unit, with reference to a classification result provided by the specifying unit.

According to the present invention, the relevant classification record specifying unit can carry out, unlike the conventional method, the data summation processing according to the complicated classification covering plural records, which cannot be classified by applying a simple rule to individual records as in the conventional method.

Moreover, the above-mentioned data summation system may be provided so that the definition which specifies the relevant classification records includes totally or partially a classification result which is obtained by applying data mining to the plurality of records composed of the plurality of data items and stored in the table form.

According to the present invention, by using the relevant classification record specifying unit, it is possible to determine whether each record about the result of data mining corresponds to a classification definition, like “the customer who purchased the goods B after purchasing the goods A”, which determination cannot be made by applying a simple rule to individual records as in the conventional method.

Moreover, the above-mentioned data summation system may be provided so that the specifying unit provides a classification result of the relevant classification records before the classification summation unit obtains the summation, and thereby the classification summation unit obtains the summation of the plurality of records composed of the plurality of data items and stored in the table form, according to the definition received by the definition unit, with reference to the provided classification result of the relevant classification records.

According to the present invention, the relevant classification record specifying unit classifies intermediately not only the method of determining the correspondence record but also the record which corresponds beforehand, and can use the intermediate classification result in the case of data summation. For example, what is necessary is just to save beforehand the key (field which can specify a record uniquely) as the intermediate classification result about the record of the customer who purchased the goods A and the goods B.

When the data summation processing is carried out about the classification definition “the customer who purchased the goods A and the goods B”, the record which corresponds with reference to the intermediate classification result is taken out. The existing method, such as the listing method, the hash method, etc. can be used for realization of the intermediate classification result. Moreover, the main storage or auxiliary storage can be chosen as a storage location of the intermediate classification result.

Furthermore, the above-mentioned data summation system may be provided so that the specifying unit is provided to update the classification result of the relevant classification records according to the definition which specifies the relevant classification record at intervals of a predetermined period.

The data as an object of the data summation is not fixed, and updating such as addition is always performed. Thus, when a record addition to the object data is present, if the classification result of the relevant classification record previously provided by the relevant classification record specifying unit is used, the newly added data is not chosen as a candidate for the data summation. In order to solve such a problem, the classification result of the relevant classification record by the relevant classification record specifying unit is updated at intervals of the predetermined period, and it is also possible to carry out the data summation of the newest data at high speed.

Furthermore, the above-mentioned data summation system may be provided so that the definition which specifies the relevant classification records is automatically registered as a classification definition.

Clustering is one technique of data mining, and in the clustering the processing for summarizing the customers having the resemblance tendency into a specified number of groups. If the cluster number (serial number starting from 1) of the result is registered automatically and used as a classification definition at this time, it is no longer needed for the user to instruct the registration to the classification definition. That is, when data mining is applied to the table-form data, the result can be registered automatically as a classification definition, and this makes it possible to carry out the data summation of the original table-form data according to the corresponding classification definition.

Furthermore, the above-mentioned data summation system may be provided so that, when the classification result of the data mining changes with time, each of the classification result of the data mining having changed is held.

According to the present invention, when the result of the data mining changes with time, the result of each data mining is held according to change of time, and it is used as a classification definition according to the result. For example, in the case of the customer with which the rank in June 2000 was 5, and the rank in July 2000 was 4, the customer is classified to the rank 5 according to the data summation in June 2000, and the customer is classified to the rank 4 according to the data summation in July 2000.

Furthermore, the above-mentioned data summation system may be provided so that the data mining is performed at intervals of a predetermined time.

According to the present invention, in addition to the definition unit, the data mining can also be performed periodically, and the corresponding record can be updated and used for the newest classification with each classification definition itself. Although the summation processing time itself does not change, the result based on the newest classification can be obtained according to the present invention.

Moreover, in order to achieve the above-mentioned objects, the present invention provides a computer-readable recording medium embodied therein for causing a computer to execute a data summation method which is equivalent to the above-mentioned data summation system of the invention.

### BRIEF DESCRIPTION OF THE DRAWINGS

Other objects, features and advantages of the present invention will be apparent from the following detailed description when read in conjunction with the accompanying drawings.

FIG. 1 is a diagram showing an example of table-form data.

FIG. 2 is a diagram showing a result of data summation of the records in the table-form data shown in FIG. 1.

FIG. 3 is a block diagram showing the composition of a conventional information processing system for utilizing the information which is stored therein.

FIG. 4 is a diagram showing an example of data mining by clustering.

FIG. 5 is a block diagram showing the composition of an information processing system in the preferred embodiment of the invention for utilizing the information which is stored therein.

FIG. 6 is a diagram showing the classification result of the relevant classification record specifying unit 502.

FIG. 7 is a diagram showing an example of the classification definition by data mining.

FIG. 8 is a diagram showing an example of the classification result of the relevant classification record specifying unit corresponding to the classification definition by data mining.

FIG. 9 is a diagram showing an example of the classification definition by clustering.

FIG. 10 is a flowchart for explaining the operation of the preferred embodiment of the invention.

FIG. 11 is a diagram showing an example of the table-form data which are the data for analysis according to the invention.

FIG. 12 is a flowchart for explaining the definition information creation and registration processing according to the invention.

FIG. 13 is a diagram showing the embodiment of the classification definition by correlation analysis.

FIG. 14 is a flowchart for explaining the classification and data summation processing according to the invention.

FIG. 15 is a diagram showing the embodiment of the specification of data summation processing according to the invention.

FIG. 16 is a diagram showing the classification result of the relevant classification record specifying unit corresponding to the classification definition by data mining.

FIG. 17 is a diagram showing the embodiment of the summation result of the data summation processing corresponding to the classification definition by data mining.

### DETAILED DESCRIPTION OF PREFERRED EMBODIMENTS

A description will now be given of the preferred embodiments of the invention with reference to the accompanying drawings.

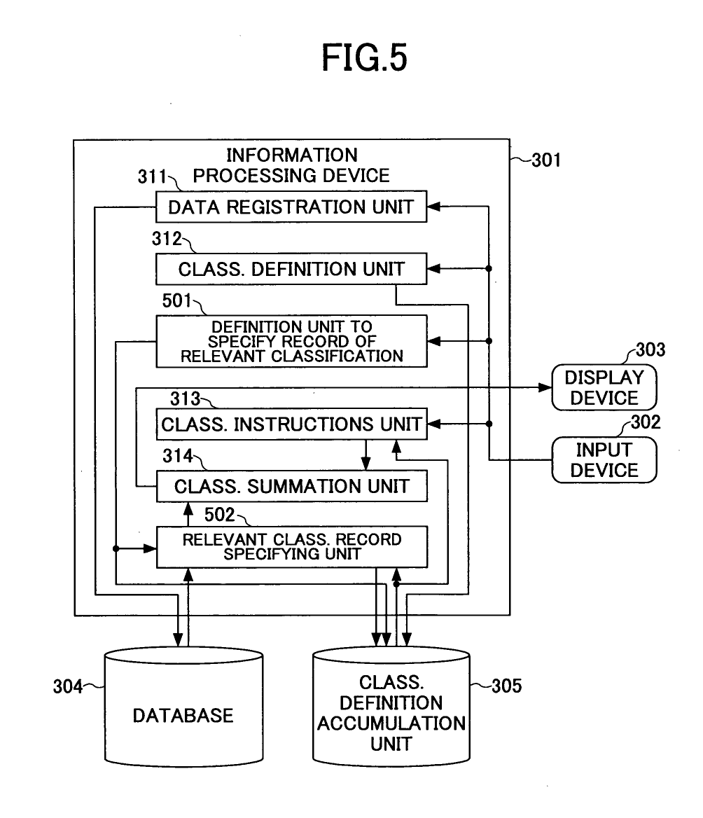

With reference to FIG. 5, the preferred embodiment of the invention will be explained.

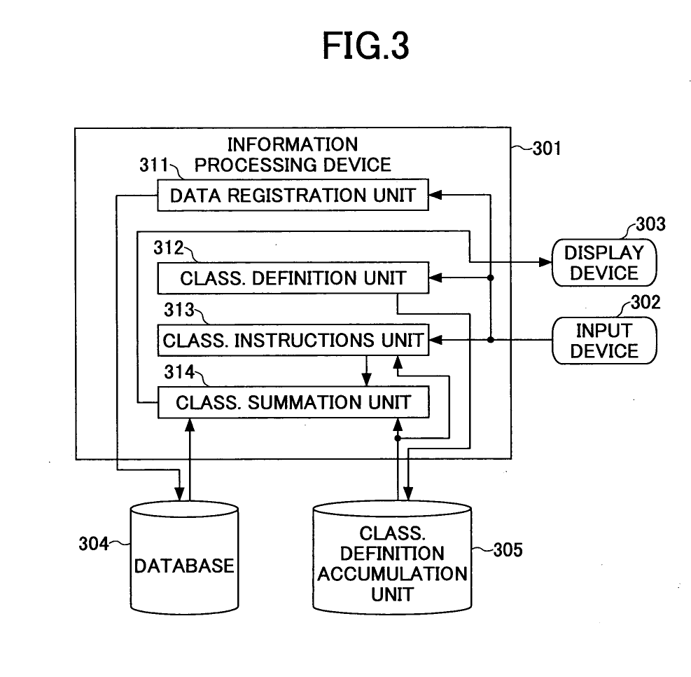

FIG. 5 shows the composition of the information-processing system in the preferred embodiment of the invention for utilizing the information which is stored therein. In FIG. 5, the elements which are the same as corresponding elements in FIG. 3 are designated by the same reference numerals.

The information-processing system of FIG. 5 comprises an information-processing device 301, an input device 302, a display device 303, a database 304, and a classification definition accumulation unit 305.

The information-processing device 301 has several units to perform various kinds of processings, and comprises the data registration unit 311, the classification definition unit 312, the classification instructions unit 313, the classification summation unit 314, a definition unit 501 to specify a relevant classification record, and a relevant classification record specifying unit 502.

The display device 303 displays a data screen etc. The input device 304 performs various inputs and it may be a mouse, a keyboard, or the like. The data registration unit 311 creates records from the data inputted from the input device 302, and registers them into the database 304 (accumulation).

The classification definition unit 312 accumulates the classification definition inputted from the input device 302 into the classification definition accumulation unit 305.

The classification instructions unit 313 specifies the classification definition accumulated in the classification definition accumulation unit 305 according to the instructions inputted from the input device 302, and sends it to the relevant classification record specifying unit 502.

The database 304 is provided to accumulate the data therein as the records. A classification definition means a definition of a classification registered in the classification definition accumulation unit 305. The definition unit 501 for specifying relevant classification records receives the definition for specifying relevant classification records according to the instructions inputted from the input device 302.

The relevant classification record specifying unit 502 classifies the record group correspond to a classification according to the definition for specifying the relevant classification record inputted into the definition unit 501 for specifying a relevant classification record, the classification definition accumulated at the classification definition accumulation unit 305, and the record accumulated at the database 304.

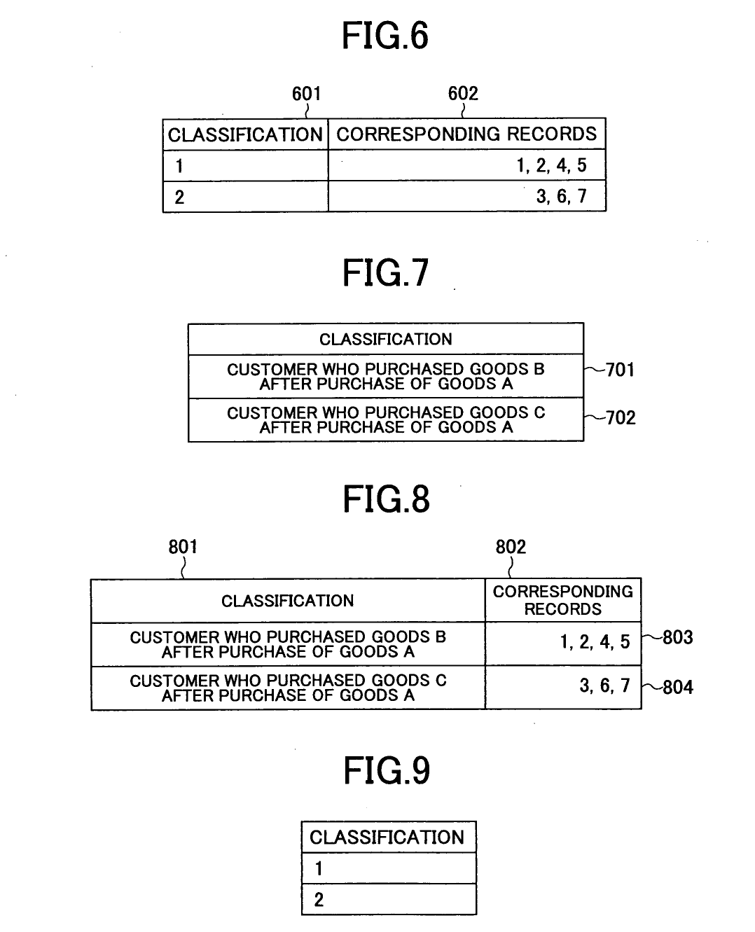

FIG. 6 shows the classification result of the relevant classification record specifying unit 502. This classification result comprises the column 601 of classification and the column 602 of corresponding records.

For example, when there are two kinds of the classification: 1 and 2, and the keys (the records) corresponding to each classification are 1, 2, 4, 5, and 3, 6, 7, as shown in FIG. 6, the correspondence table of the record to classification 1 and classification 2 is created as an intermediate classification result, and the corresponding record group can be detected immediately from this correspondence table.

The classification summation unit 314 classifies the records accumulated in the database 304, and performs data summation processing for the classified records. The classification summation unit 314 makes reference to the classification definition accumulated in the classification definition accumulation unit 305 specified by the classification instructions unit 313, and makes reference to the classification result as in the table of the records corresponding to the classification 1 and classification 2 as shown in FIG. 6, which are outputted from the relevant classification record specifying unit 502. The classification summation unit 314 specifies the relevant classification record, takes out the record corresponding to each classification from those accumulated in the database 304 one by one. The classification summation unit 314 divides them into the corresponding classification, and carries out the data summation processing for the classified records. For example, it is possible to divide them into application-period classifications according to the purposes of the product lineup respectively, and define and register each classification.

It is necessary to prepare, in advance, the intermediate classification result by the relevant classification record specifying unit 502 according to the classification definition. And the results classified and totaled are displayed on the display device 303 by the classification summation unit 314. Thus, the classification summation unit 314 can perform easily data summation processing for the record group corresponding to each classification by using the relevant classification record specifying unit 502.

Thus, unlike the conventional method, the data summation processing by the complicated classification covering two or more records which cannot classify only according to applying a simple rule to each record is attained by using the classification result of the relevant classification record specifying unit 502 according to the present invention.

Moreover, a part or all of the results of data mining can be used as a definition for specifying the relevant classification record defined by the definition unit 501 for specifying a relevant classification record.

FIG. 7 shows the example of the classification definition using the result of data mining.

About the result of data mining, even if it sees only each record, it cannot be determined which of the classification definitions the record matches with. For example, in the case of FIG. 7, in order to judge whether it is classified into “the customer who purchased the goods B after purchasing the goods A” (701), it becomes only a requirement only by the goods A being indicated by the single record. For this reason, it can be determined by using the relevant classification record specifying unit 502 to which classification definition each record corresponds.

Furthermore, in the case of data summation of records, the relevant classification record specifying unit 502 can use not only the method of determining the correspondence records but also the method of obtaining the intermediate corresponding records beforehand and using the intermediate classification results at the time of data summation.

FIG. 8 shows the example of the classification result of the relevant classification record specifying unit corresponding to the classification definition using the result of data mining. The classification result comprises the column 801 of classification and the column 802 of correspondence record group.

For example, what is necessary is just to save beforehand, the key (field which can specify a record uniquely) as the intermediate result about “the record of the customer who purchased the goods A and the goods B” (803), as shown in FIG. 6.

And when data summation processing is carried out for the classification definition “the customer who purchased the goods A and the goods B”, a corresponding record is taken out with reference to the intermediate classification result. In order to realize the intermediate classification result, the existing method, such as the listing, the hash method, etc. can be used. Moreover, the intermediate classification result can be stored in the main storage or the auxiliary storage.

Moreover, addition of a record is regularly performed in the database 304 to the data set as the object of a classification on the property. Thus, the record added after generating the above correspondence tables which specify the record contained in the classification result of the relevant classification record specifying unit 502, when a record was added to the data set as the object of a classification and the classification result of the relevant classification record specifying unit 502 generated at once was used will be contained in the object of data summation processing.

In order to solve such a problem, the above-mentioned processing of the relevant classification record specifying unit 502 is performed to update the correspondence table which specifies the record contained in the classification at intervals of a predetermined period. By the updating to the newest data at intervals of the fixed time, it is possible to carry out data summation at high speed also.

Furthermore, in clustering which is the one technique of data mining, processing which gathers the near record of a tendency in the group of the specified number is performed. If the cluster number (serial number starting from 1) of a result is automatically registered at this time and it can use for it as a classification definition, it will become unnecessary for a user to direct registration through the input device 302 to a definition unit 501 to specify a relevant classification record.

That is, when data mining is performed to table-form data, the result can be automatically registered into the classification definition accumulation unit 305 as a definition which specifies a relevant classification record, and it can make it possible to total according to the classification definition which corresponds the original table-form data.

FIG. 9 shows the example of the classification definition by clustering.

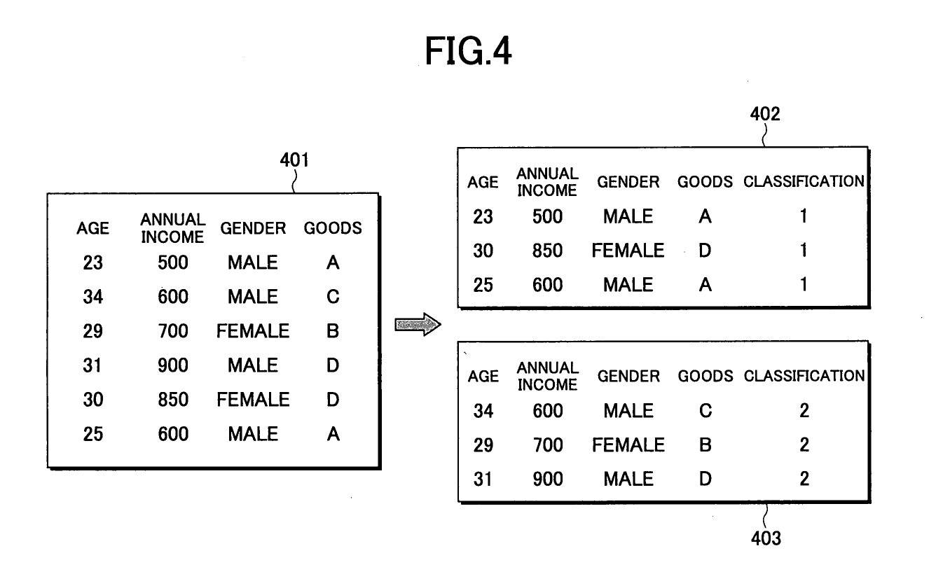

For example, in the example shown in FIG. 4, the classification definition of FIG. 9 is formed automatically, and it is accumulated in the classification definition accumulation unit 305.

Furthermore, when the result of data mining changes with time, the result of each data mining is held according to change of time, and it can use as a classification definition according to the result.

For example, although the rank was 5 in June 2000, in the case of the customer from whom the rank was set to 4, it can classify into a rank 5 according to the total in June 2000, can total in July 2000, and can total as a rank 4 in July 2000.

Furthermore, in addition to the classification definition record specifying unit 502, data mining can also be performed periodically, and each classification definition itself and the intermediate classification definition of the corresponding record can be updated and used for the newest thing.

Although the time itself to perform a total does not change, the result based on the newest classification can be obtained by this. The invention can be provided as a record medium which stored the program for making it function on a computer and in which computer reading is possible.

Next, the flowchart is used and operation of the invention will be described in detail.

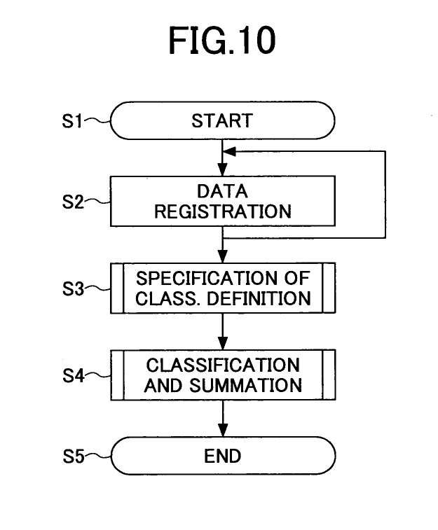

FIG. 10 is the flowchart for explaining operation of the preferred embodiment of the invention. The whole operation will be described according to the flowchart of FIG. 10.

First, the operation of FIG. 10 is started at step S1.

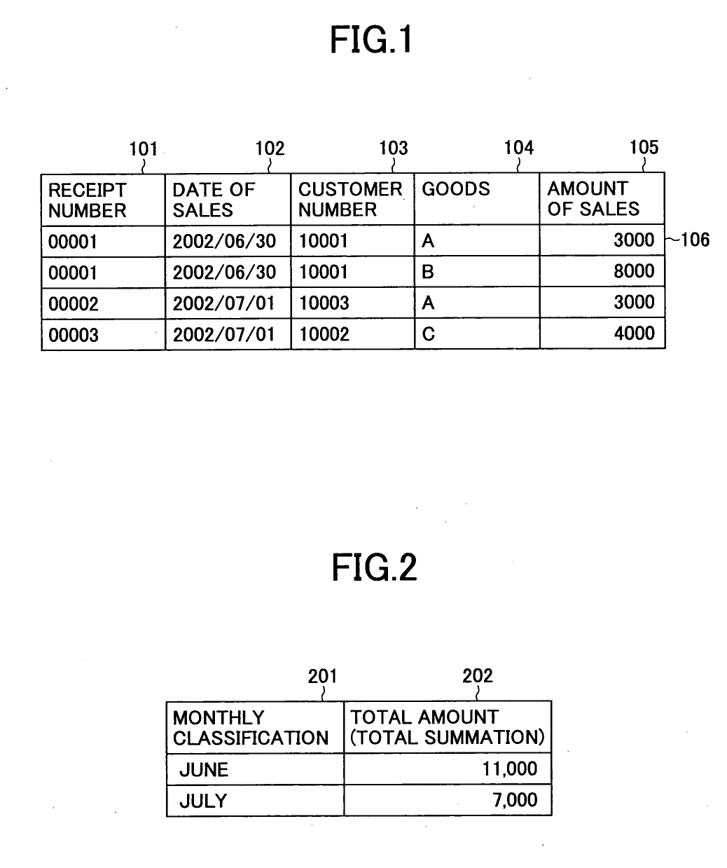

At step S2, the data inputted into the data registration unit 311 through the input device 302 of FIG. 5 are registered into the database 304. This makes the customers, the goods, the sales, etc. into the records stored for every transaction and registered as shown in FIG. 1.

Next, at step S3, through the input device 202 of FIG. 5, a classification definition is specified to the definition unit 501 to specify the classification definition record and the classification definition unit 311, and it is accumulated in the classification definition accumulation unit 305. This step S3 is characterized in that a classification definition based on the complicated rule like the results of data mining, which cannot be classified according to the conventional single record method, is performed.

Next, at step S4, classification and data summation processing is performed based on the data inputted at the above-mentioned steps S2 and S3, and the classification definition. This takes out the corresponding classification definition dictionary from the classification definition accumulation unit 305 of FIG. 5 corresponding to specification of the purpose, according to the classification rule of the classification definition concerned, takes out the record which corresponds with a relevant classification record, and performs data summation.

And the operation is terminated at step S5.

Accordingly, the data summation processing by the classification definition based on the complicated rule can be performed by registering and accumulating data in the database 304, creating the classification definition based on the complicated rule, registering with the classification definition accumulation unit 305, and totaling about the record corresponding to the classification using the relevant classification record specifying unit 502 shown in FIG. 5.

Next, steps S2, S3, and S4 will be described in detail below.

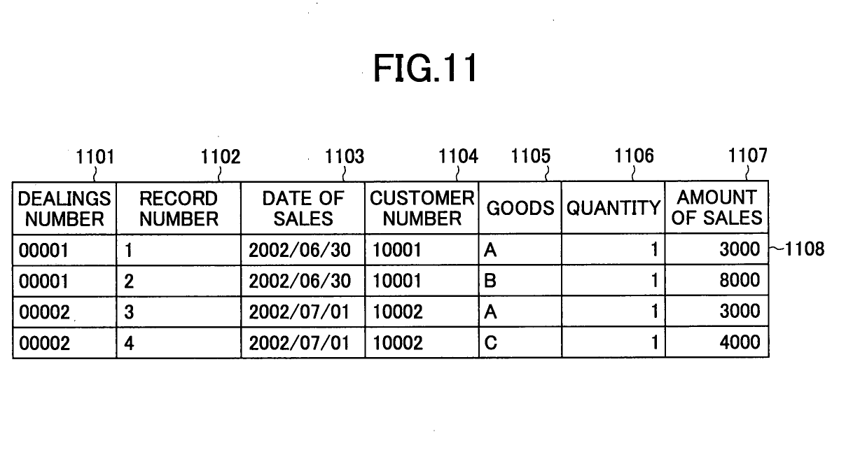

FIG. 11 shows an example of the table-form data which are the data for analysis of the invention registered at step S2. In the example of FIG. 11, the dealing number of reference numeral 1101, the record number of reference numeral 1102, the date of sales of reference numeral 1103, the customer number of reference numeral 1104, the goods of reference numeral 1105, the quantity of reference numeral 1106, and the amount of sales of reference numeral 1107, which are arrayed in columns of the table, constitute the respective fields.

For example, the record 1108 at the first line of this table-form data comprises data items of the respective fields: the product the dealing number: 00001 (serially assigned at the time of selling), the record number: 1, the date of sales: Jun. 30, 2002, the customer number: 10001, the goods: A, the quantity: 1, and the amount of sales: 3000. These data items are stored and registered in the record 1108 (accumulation).

At step S2 of FIG. 10, the data are inputted to form such records and registered in the database 304. As mentioned above, by associating with the date of sales, the records including the dealing number, the date of sales, the customer number, the quantity, the amount of sales, etc. are registered and accumulated in the database. The data summation can be carried out using the classification rule which meets the purpose of analysis, according to the classification definition which will be mentioned later.

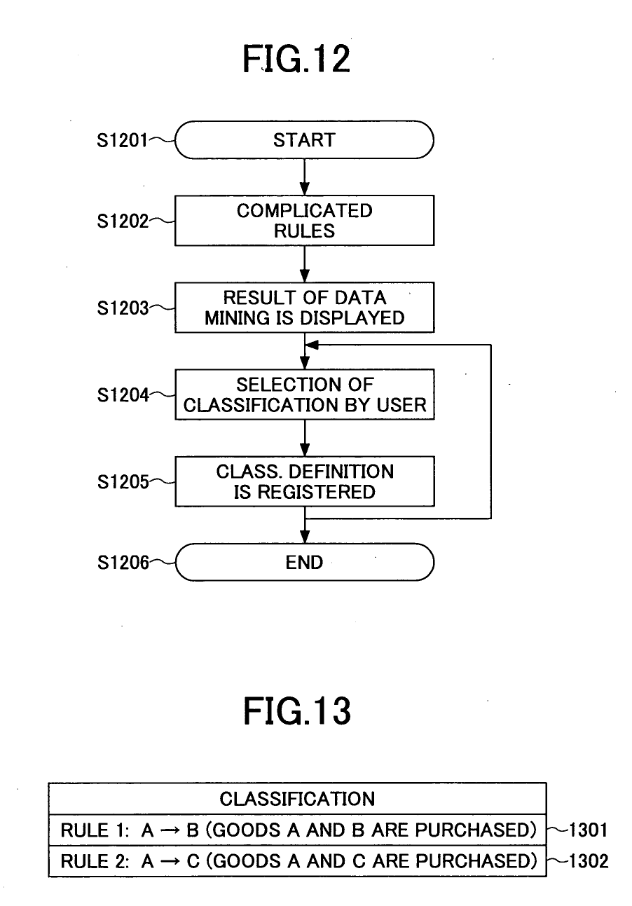

Next, specification of classification definition of step S3 will be described using FIG. 12.

FIG. 12 is the flowchart for explaining the definition information creation and registration processing according to the invention.

As shown in FIG. 12, the creation and registration processing of definition information is started at step S1201.

Next, at step S1202, the classification under a complicated rule like data mining is performed to the target data by using the classification summation unit 314 of FIG. 5.

Next, at step S1203, the result of data mining is displayed by the classification summation unit 314 of FIG. 5. For example, suppose that the following two rules are obtained with the application of correlation analysis for the data of FIG. 11.

Rule 1: A->B (A and B are purchased together)

Rule 2: A->C (A and C are purchased together)

Next, the user defines how the result of data mining is used as a classification by step S1204 to a definition unit 501 to specify the relevant classification record of FIG. 5, through the input device 302.

When the above rules are obtained, both the rule 1 and the rule 2 are defined as a classification. This makes it possible to create a classification definition as shown in FIG. 13 based on the data of FIG. 11.

FIG. 13 is a diagram showing the preferred embodiment of the classification definition by correlation analysis, and has two classifications 1301 and 1302.

Next, it is step S1205 and the classification definition obtained by doing in this way is accumulated for the classification definition accumulation unit 305 of FIG. 5.

And creation and registration processing of definition information are ended at step S1206.

Next, the classification and data summation of step S4 of FIG. 10 will be described.

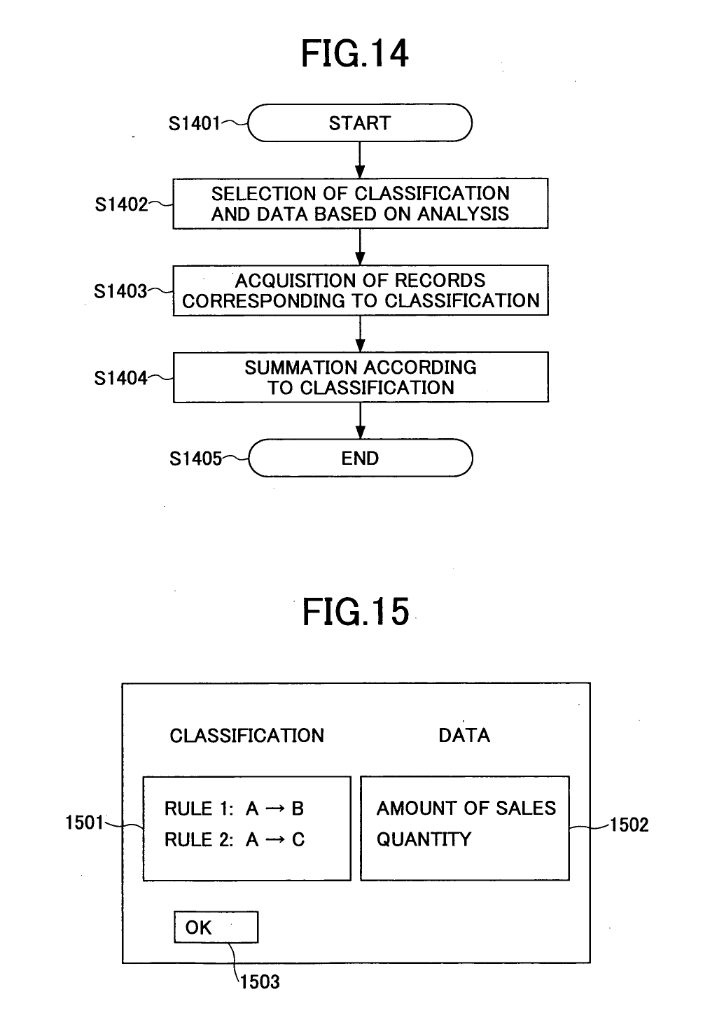

FIG. 14 is the flowchart for explaining the classification and data summation processing according to the invention. FIG. 15 shows the embodiment of specification of data summation processing according to the invention.

In the flowchart of FIG. 14, the classification and data summation processing is started at step S1401.

Next, at step S1402, by using the classification summation unit 314 of FIG. 5, a selection screen is displayed based on the classification definition and data, and this selection screen contains the classification and data as shown in FIG. 15.

As shown in FIG. 15, the display screen includes the classification of reference numeral 1501, the data of reference numeral 1502, and the O.K. button 1503 which outputs the instructions to make the selection.

The user chooses a classification and data through the input device 302 according to the analysis. In this case, it is also possible to choose two or more classifications.

Next, at step S1403, the records which correspond to the specified classification are obtained by using the classification record specifying unit 502 of FIG. 5.

In obtaining the records, there are the two methods: one of the methods is to perform the processing according to the specification at the time of data summation, and the other is to create the corresponding records beforehand.

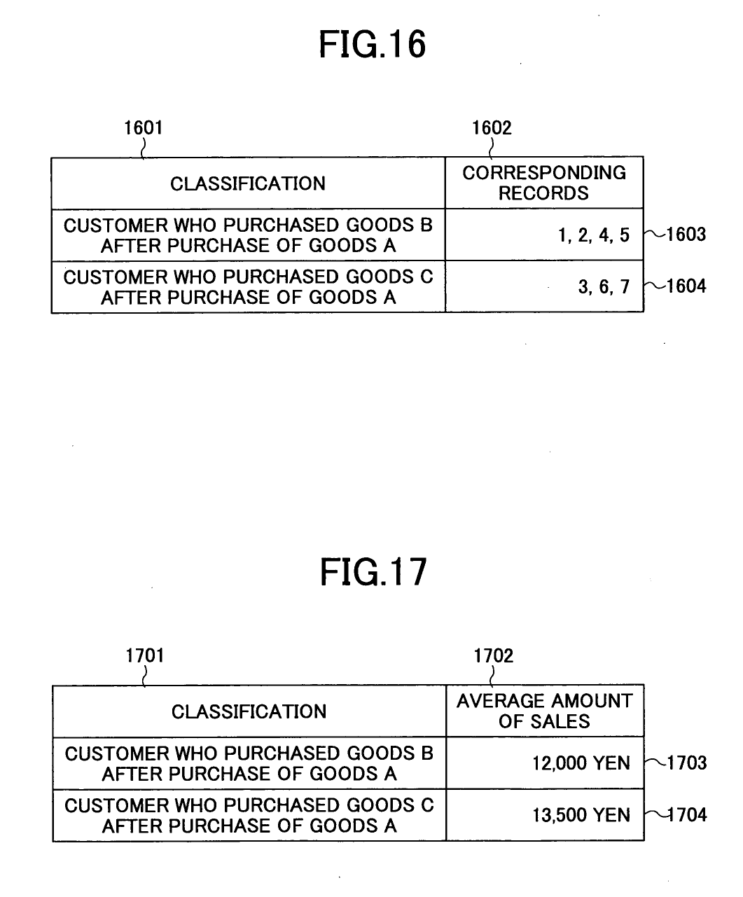

FIG. 16 shows an example of the corresponding records group obtained to the classification definition of FIG. 13. The example of FIG. 16 shows the execution result of the relevant classification record specifying unit 502 corresponding to the classification definition by data mining, and comprises the column 1601 and the correspondence record column 1602.

When the classification record specifying unit 502 of FIG. 5 creates the table of FIG. 16 as the intermediate classification result, it can express by holding a correspondence record group using a table for every classification.

When there are many classifications and the search for the corresponding records takes time, the time for the retrieval of the classifications can be shortened by registering them with a hash table.

Next, the records corresponding to the selected classification are checked at step S1404. According to the checked result, classification and data summation is performed about the corresponding classification.

FIG. 17 shows the embodiment of the execution result of the data summation processing corresponding to the classification definition by data mining, and comprises the column 1701 and the average-sales column 1702.

In the example of FIG. 17, the average amount of sales is calculated for the customers corresponding to the classification definition of FIG. 13.

As explained above, the determination as to whether a certain record is relevant to the classification “the customer who purchased the goods B after purchasing the goods A” is not correctly made by applying the rules to the individual single records solely. However, according to the present invention, it is possible to attain the data summation processing using such classifications based on the rules covering two or more records.

The present invention is not limited to the above-described embodiments, and variations and modifications may be made without departing from the scope of the present invention.

1. A data summation system which obtains a summation of a plurality of records, which are composed of a plurality of data items and stored in a table form, based on a predetermined rule, the system comprising:
a definition unit receiving a definition which specifies records of relevant classification covering two or more records stored in the table form;
a specifying unit specifying the records of the relevant classification covering the two or more records; and
a classification summation unit obtaining a summation of the plurality of records composed of the plurality of data items and stored in the table form, according to the definition received by the definition unit, with reference to a classification result provided by the specifying unit.

2. The data summation system according to claim 1 wherein the definition which specifies the relevant classification records includes totally or partially a classification result which is obtained by applying data mining to the plurality of records composed of the plurality of data items and stored in the table form.

3. The data summation system according to claim 1 wherein the specifying unit provides a classification result of the relevant classification records before the classification summation unit obtains the summation, and thereby the classification summation unit obtains the summation of the plurality of records composed of the plurality of data items and stored in the table form, according to the definition received by the definition unit, with reference to the provided classification result of the relevant classification records.

4. The data summation system according to claim 1 wherein the definition which specifies the relevant classification records is updated at intervals of a predetermined period.

5. The data summation system according to claim 3 wherein the specifying unit is provided to update the classification result of the relevant classification records according to the definition which specifies the relevant classification record at intervals of a predetermined period.

6. The data summation system according to claim 2 wherein the definition which specifies the relevant classification records is automatically registered as a classification definition.

7. The data summation system according to claim 2 wherein, when the classification result of the data mining changes with time, each of the classification result of the data mining having changed is held.

8. The data summation system according to claim 2 wherein the data mining is performed at intervals of a predetermined time.

9. A data summation method which obtains a summation of a plurality of records, which are composed of a plurality of data items and stored in a table form, based on a predetermined rule, the method comprising the steps of:
receiving a definition which specifies records of relevant classification covering two or more records stored in the table form;
specifying the records of the relevant classification covering the two or more records; and
obtaining a summation of the plurality of records composed of the plurality of data items and stored in the table form, according to the definition received in the receiving step, with reference to a classification result provided in the specifying step.

10. The data summation method according to claim 9 wherein the definition which specifies the relevant classification records includes totally or partially a classification result which is obtained by applying data mining to the plurality of records composed of the plurality of data items and stored in the table form.

11. The data summation method according to claim 9 wherein in the specifying step a classification result of the relevant classification records is provided before the summation is obtained, and thereby in the obtaining step the summation of the plurality of records composed of the plurality of data items and stored in the table form is obtained according to the definition received in the receiving step, with reference to the provided classification result of the relevant classification records.

12. The data summation method according to claim 9 wherein the definition which specifies the relevant classification records is updated at intervals of a predetermined period.

13. The data summation method according to claim 11 wherein the specifying step is provided to update the classification result of the relevant classification records according to the definition which specifies the relevant classification record at intervals of a predetermined period.

14. The data summation method according to claim 10 wherein the definition which specifies the relevant classification records is automatically registered as a classification definition.

15. The data summation method according to claim 10 wherein, when the classification result of the data mining changes with time, each of the classification result of the data mining having changed is held.

16. The data summation method according to claim 10 wherein the data mining is performed at intervals of a predetermined time.

17. A computer-readable recording medium storing a program embodied therein for causing a computer to execute a data summation method which obtains a summation of a plurality of records, which are composed of a plurality of data items and stored in a table form, based on a predetermined rule, the data summation method comprising the steps of:
receiving a definition which specifies records of relevant classification covering two or more records stored in the table form;
specifying the records of the relevant classification covering the two or more records; and
obtaining a summation of the plurality of records composed of the plurality of data items and stored in the table form, according to the definition received in the receiving step, with reference to a classification result provided in the specifying step.
